(19) United States
(12) Patent Application Publication
(10) Pub. No.: US 2005/0190269 A1
(43) Pub. Date: Sep. 1, 2005

(54) Transferring data between devices

(75) Inventor: Raphael Grignani, Helsinki (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/871,792

(22) Filed: Jun. 18, 2004

(30) Foreign Application Priority Data
Feb. 27, 2004 (FI) 20040318

(51) Int. Cl. H04N 5/232

(52) U.S. Cl. 348/211.2

(57) ABSTRACT

The present invention relates to a method for transferring data files between a sending device and a first receiving user equipment to be sent further to a second receiving user equipment. The method comprises receiving in the first receiving user equipment information comprising at least one data file transferred from the sending device using a first transfer method. Further, the method comprises creating, in the first receiving user equipment, a message comprising the at least one data file in a form suitable to be sent to the second receiving user equipment. The received information may comprise an instruction to create the message. In an embodiment, the message may be created automatically in response to receiving the information. In an embodiment, the data file may be modified into a form suitable for transferring.

### FIELD OF THE INVENTION

The present invention relates to communication systems and, in particular, to transferring data between a sending device and a first receiving user equipment to be sent further to a second receiving user equipment.

### BACKGROUND OF THE INVENTION

In a communication system, two or more entities, such as user equipment and/or other nodes associated with the communication system, may communicate with each other. Communication systems may be fixed, such as the public switched telephone network (PSTN), or mobile, such as the global system for mobile communication (GSM) or various GSM based systems, such as general packet radio service (GPRS), third generation standards, such as the universal mobile telecommunication system (UMTS) and other communication systems that are based on the wideband code division multiple access (WCDMA). A communication system may also be based on local area network (LAN) standards.

Subscribers, such as the users, to a communication system may be offered and provided numerous services, like two-way or multi-way calls, data communication or multimedia services. In addition to call functions, the communication systems may support, for example, short message service (SMS), multimedia message service (MMS) and wireless applications protocol (WAP). A user may access a network of a communication system by means of a user equipment, such as a personal computer (PC), personal digital assistant (PDA), mobile station (MS) and so on.

User equipment may communicate with further user equipment or other devices, such as camera or music player, compatible with the first user equipment. A compatible device may be connected to the user equipment using various connections including, but not limited to, galvanic connections, such as universal serial bus (USB) port, Pop-Port interface, and so on, and wireless connections, such as Bluetooth, infrared, wireless local area network (WLAN) and so on, optical connections and direct connector connections.

It may be desirable to be able to connect to user equipment also a device which is not designed to cooperate with the particular user equipment. For example, a digital camera may conveniently be used to create image files of still or moving images. A digital camera may have resolution capacity for example up to 3 megapixels (Mp). The image file obtained using such a 3 Mp digital camera may vary from about 60 kB to several megabytes depending on the settings of the camera. Often, users tend to take high resolution images, i.e. images of several megabytes. Typically, the image files may be transferred to a PC or another such relatively high capacity receiving user equipment. Such relatively high capacity receiving user equipment need not necessarily be designed compatible with the digital camera.

However, it might be desirable also to be able to transfer files, such as image files, from a sending device, such as a digital camera, to more limited capacity receiving user equipment, in particular to mobile user equipment, such as a MS or a PDA, an image viewer, and so on. Furthermore, it may be desirable to be able to send such a file further as an MMS message or an email to a second receiving user equipment, such as another MS or PDA, or a PC. This may be possible, but typically requires manual intervention of the user, which may be quite complicated. The user of the sending device may need to know the type of at least the first receiving user equipment and, in some cases, even the second receiving user equipment. The user may need to know possible limitations relating to the receiving user equipment or correspondingly the type and possible limitations relating to a transfer method to be used. The user may need to manually modify the file in order to adapt the file in the requirements set by a transfer method and/or receiving user equipment.

There is, therefore, a need for an improved method for transferring files between devices.

### SUMMARY OF THE INVENTION

Embodiments of the present invention aim to address one or several of the above problems or issues.

According to an aspect of the present invention, there is provided a method for transferring data files between a sending device and a first receiving user equipment to be sent further to a second receiving user equipment. The method comprises receiving, in the first receiving user equipment, information comprising at least one data file transferred from the sending device using a first transfer method. Furthermore, the method comprises, in response to receiving the information, creating a message comprising the at least one data file in a form suitable to be sent to the second receiving user equipment using a second transfer method. The step of receiving the information may further comprise receiving an instruction to create the message. The step of creating the message may comprise automatically opening a message editor and automatically attaching the at least one data file to the message. Creating the message may further comprise allowing addition of other material to the message.

According to a further aspect of the invention, there is provided a method for transferring data files between a sending device and a first receiving user equipment to be sent further to a second receiving user equipment. The method comprises transferring at least one data file from the sending device to the first receiving user equipment using a first transfer method. Furthermore, the method comprises instructing the first receiving user equipment to create a message comprising the at least one data file in a form suitable to be sent to the second receiving user equipment using a second transfer method.

The method may further comprise assessing, based on the first transfer method, if at least one of said at least one data file is to be modified; and, in response to finding that at least one of said at least one data file is to be modified, modifying said data file into a form suitable for transferring using the first transfer method. Assessing is preferably carried out by the sending device.

The method may further comprise assessing, based on the second transfer method, if at least one of said at least one data file is to be modified; and, in response to finding that at least one of said at least one data file is to be modified, modifying said data file into a form suitable for transferring using the second transfer method. Assessing is preferably carried out by the sending device.

The modifying step may further comprise creating a clone data file of the original data file and modifying the clone data file.

In an embodiment, the data file may be modified based on capacity limitations of the first transfer method, such as a maximum file size supported by the first transfer method.

In an embodiment, the data file may be modified based on capacity limitations of the first receiving user equipment, such as a maximum file size supported by the first receiving user equipment.

In an embodiment, the data file may be modified based on capacity limitations of the second transfer method, such as a maximum file size supported by the second transfer method.

Modifying may comprise compressing the data file. In an embodiment, modifying may comprise changing the format of the data file. For example, the data file may be modified from JPEG to GIF image format, based on information relating to the transfer method or the receiving device.

In an embodiment, the data file to be transferred is an image file. Then, the setp of modifying may comprise re-sizing the at least one image file. The step of modifying may further comprise re-scaling the at least one re-sized image file.

In an embodiment, the data file to be transferred is an image file. The step of modifying may then comprise the changing of the data file format to JPEG from a non-JPEG format and to additionally re-size the image if the image size is not suitable for subsequent sending of a message, such as an MMS message, by the receiving user equipment.

The sending device may obtain an indication relating to the first transfer method. In an embodiment, the indication is obtained by determining by the sending device an active transfer method capable of transferring the information to the first receiving user equipment. In an embodiment, the indication is obtained by receiving in the sending device the indication sent by the first receiving user equipment. In an embodiment, the indication is obtained by displaying to a user of the sending device a list of transfer methods and allowing the user to select an indication belonging to the list.

The sending device may also obtain an indication relating to the second transfer method. In an embodiment, the indication is obtained by obtaining an indication of existence or non-existence of a support for a particular second transfer method in the first receiving device, such as a support for multimedia message service and/or electronic mail.

The at least one data file to be transferred may be selected from a plurality of data files in the sending device.

According to a further aspect of the invention, there is provided a method for transferring data files between a sending device and a first receiving user equipment to be sent further to a second receiving user equipment. The method comprises transferring information comprising at least one data file from the sending device to the first receiving user equipment using a first transfer method. Furthermore, the method comprises receiving the information comprising the at least one data file in the first receiving user equipment. Furthermore, the method comprises creating, in the first receiving user equipment, a message comprising the at least one data file in a form suitable to be sent to the second receiving user equipment using a second transfer method.

According to a further aspect of the invention, there is provided a computer program comprising program code means for performing any of the steps according to any of the methods of the invention when the program is run on a computing means.

According to a further aspect of the invention, there is provided user equipment configured to receive information comprising at least one data file transferred from a separate device using a first transfer method. The user equipment is further configured to initiate, in response to receiving the information, an automatic creation of a message comprising the received at least one data file; and to send the message further to a second user equipment using a second transfer method.

According to a further aspect of the invention, there is provided a device configured to transfer at least one data file from the device to a first receiving user equipment using a first transfer method and to instruct the first receiving user equipment to create a message comprising the at least one data file in a form suitable to be sent to a second receiving user equipment using a second transfer method.

The device may be further configured to assess, based on the first transfer method, if at least one of said at least one data file is to be modified; and, in response to finding that at least one of said at least one data file is to be modified, to modify the at least one data file into a form suitable for transferring using the first transfer method. The device may be further configured to assess, based on the second transfer method, if at least one of said at least one data file is to be modified; and, in response to finding that at least one of said at least one data file is to be modified, modify the at least one data file into a form suitable for transferring using the second transfer method.

According to a further aspect of the invention, there is provided an arrangement for transferring data files between a sending device and a first receiving user equipment to be sent further to a second receiving user equipment. The arrangement comprises sending means, in the sending device, for sending information comprising at least one data file to the first receiving user equipment using a first transfer method. Furthermore, the arrangement comprises receiving means, in the first receiving user equipment, for receiving the information comprising the at least one data file. Furthermore, the arrangement comprises message creating means, in the first receiving user equipment, for creating a message comprising the at least one data file in a form suitable to be sent to the second receiving user equipment using a second transfer method.

The first receiving device may comprise mobile user equipment, a mobile station or a personal digital assistant. The sending device may comprise a digital camera. The sending device is preferably a device which does not support multimedia message service or electronic mail. The first transfer method may be selected from a group comprising: universal serial bus port connection, Pop-Port connection, other galvanic connection, Bluetooth connection, infrared connection, wireless local area network connection, other wireless connection, direct connector connection or optical connection. The second transfer method may be multimedia message service or electronic mail. The sending device and the first and the second receiving user equipment are preferably stand-alone devices.

### BRIEF DESCRIPTION OF FIGURES

The invention will now be described in further detail, by way of example only, with reference to the following examples and accompanying drawings, in which:

FIG. 1 shows an example of an arrangement in which the embodiments of the invention may be implemented;

FIG. 2 shows a flowchart of an embodiment of the invention;

FIG. 3 shows a flowchart of a further embodiment of the invention;

FIG. 4 shows a flowchart of another further embodiment of the invention; and

FIG. 5 shows an example of a user interface flow which may be used in embodiments of the invention.

### DETAILED DESCRIPTION OF THE PREFERRED EMBODIMENTS

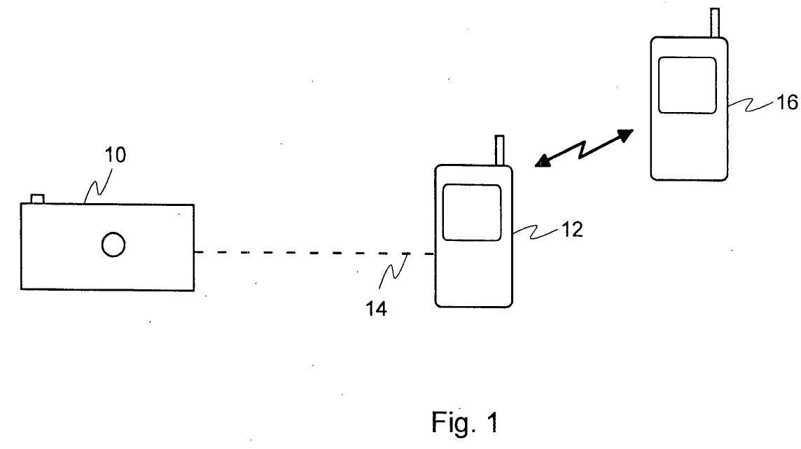

FIG. 1 shows an example of an arrangement of a digital camera as a sending device 10 and a mobile station as a first receiving user equipment 12. The sending device 10 and the first receiving user equipment 12 communicate with each other using a first transfer method 14, such as a local transfer method for example over an air interface using a wireless technology, such as the Bluetooth. The first transfer method 14 may be any appropriate local scale transfer method, for example a wireless link, a galvanic connection or a direct connector connection, some examples of which were given above. The sending device is a device, which does not support sending messages by means of the MMS or email.

Moreover, a second receiving user equipment 16, such as another mobile station, is shown. The two receiving user equipment 12, 16 may communicate using a second transfer method, which may be operated in accordance with any appropriate communication system. In the FIG. 1, the two receiving user equipment 12, 16 are shown to communicate via a radio interface. It shall be appreciated that the digital camera and the mobile stations are used as said sending and receiving devices for illustrative purposes in a way of example only. These devices may as well be any other appropriate devices between which a file is to be transferred. These devices need not to be designed compatible with each other. The devices are operable by themselves, i.e. the devices are stand-alone. Embodiments of the invention are described herein mainly referring to transfer of image files, but the files may also be other appropriate files, such as music files or multimedia files.

A user may wish to transfer data created by means of the sending device 10 first to the receiving user equipment 12 and then further to the second receiving user equipment 16, for example, as an MMS message or an email.

Before transferring a file to a first receiving user equipment 12 not designed compatible with the sending device 10, characteristics, such as certain limitations, of the transfer method and/or the first receiving user equipment need to be known. The first receiving user equipment or the transfer method used between the sending device and the first receiving user equipment may have limitations for example relating to the file size. The storing capacity of the receiving user equipment may be lower than the file to be transferred requires. The transfer method between the sending device and the first receiving user equipment may support only a limited file size. In some user equipment, for example a message to be sent further, such as an MMS, may be limited to a certain file size, for example about 32 kB. The original image file may be several times bigger, for example about 1,2 MB.

To be able to transfer the file from the sending device, such as a digital camera, to the receiving user equipment, such as a mobile station, the sending device needs to re-size, or compress, the files to fit to the limitation. To obtain again an acceptable image from the transferred file, re-scaling may be needed. For example, when the original image file of 1,2 MB is re-sized to an image file of 32 kB, an important part of details and color information may be lost. After re-scaling, the image may be viewed almost as the original, but in small dimensions. Other appropriate data compressing methods may also be used. In an embodiment, the format of the data file may be changed dependent of information received from the receiving user equipment. For example, when a further action takes place in the receiving user equipment, such as the example above of sending an MMS message, the preferred file format is an image file formatted according to the JPEG standard whereas the original data file may be formatted according to an uncompressed, unprocessed RAW image format Therefore, in response to receiving the information from the receiving user equipment, such as a mobile station, the sending device, such as a digital camera, may reformat the RAW image file into a JPEG image file, and possibly re-sizing the file, before transferring the file to the receiving user equipment.

In another example, the original data file may be a JPEG image file and the receiving user equipment may include a contacts database which supports only GIF image files. The sending device may assess based on information received from the receiving user equipment that conversion of the JPEG image file into the GIF format is required. The sending device will then perform the conversion prior to transferring the file to the receiving user equipment. The GIF image file transferred to the receiving user equipment may then be added to a record in the contacts database.

It has now been found that a procedure may be implemented to improve the communication between the first receiving user equipment and the sending device. Thereby, file transfer may be improved and partially or entirely automated. It may be desired that sending the message to the second receiving user equipment might be initiated already in the sending device.

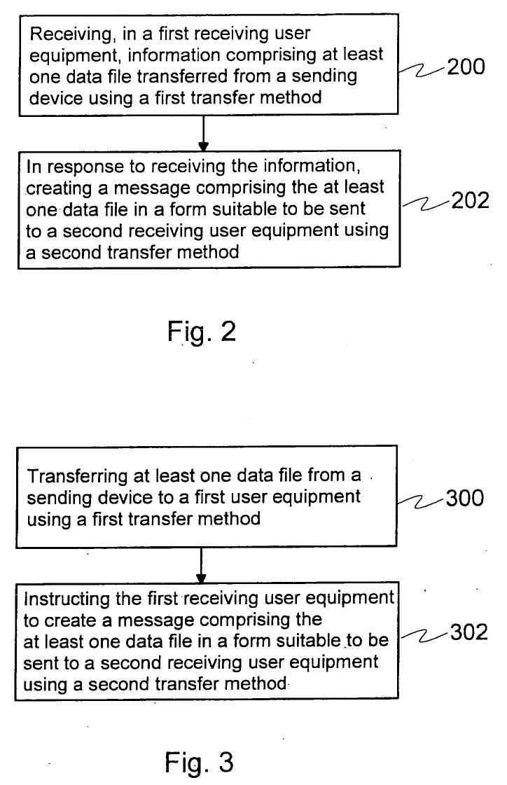

FIG. 2 shows a flow chart illustrating an embodiment of the invention for transferring data files between a sending device and a first receiving user equipment to be sent further to a second receiving user equipment. In step 200, information comprising at least one data file transferred from the sending device using a first transfer method is received in the first receiving user equipment. In step 202, in response to receiving the information, a message comprising the at least one data file is created in a form suitable to be sent to the second receiving user equipment using a second transfer method. In an embodiment, the received information comprises an instruction to create the message. The message may be created by automatically opening a message editor in the first receiving user equipment and by automatically attaching the at least one data file to the message. A user may be allowed to add other material, such as text, to the message.

FIG. 3 shows a flow chart illustrating a further embodiment of the invention. In step 300, at least one data file is transferred from a sending device to a first user equipment using a first transfer method. In step 302, the first receiving user equipment is instructed to create a message comprising the at least one data file in a form suitable to be sent to a second receiving user equipment using a second transfer method.

In an embodiment, based on the first transfer method, it may be assessed if at least one of said at least one data file needs to be modified. Preferably, the assessing step is carried out in the sending device. In response to finding that at least one said at least one data file needs to be modified, the data file is modified into a form suitable for transferring using said first transfer method. A similar assessing step may be carried out based on the second transfer method. In response to finding that at least one said at least one data file needs to be modified, the data file is modified into a form suitable for transferring using said second transfer method. In a preferred embodiment, in response to finding that at least one of said at least one data file needs to be modified, a clone data file is created of each original data file, which needs to be modified. The modification is then carried out for the clone data file.

In an embodiment, the first transfer method, the second transfer method or the first receiving device 12 may have lower capacity in respect of the file size than the file size of the data to be transferred. Modifying the data may thus comprise reducing the file size of the data to be transferred. Some embodiments are explained in the following description. Other appropriate ways may also be used.

Various steps of the embodiments may require a computer program comprising program code means to be introduced in the first receiving device and, in some embodiments, also in the sending device.

Furthermore, a device configured to work in accordance with the embodiments of the invention is provided. In some embodiments, no modifications are needed in the sending device 10, but the first receiving device 12 provides all the required information and functionality. In some embodiments, the functionalities may be shared between the sending device 10 and the first receiving user equipment 12 in an appropriate manner. These alternatives shall become apparent from the following description.

In a sending device 10, such as a digital camera, a device menu, also called gallery, typically provides a possibility to select desired images, some editing features, and so on. In an embodiment, the device menu is provided with a feature for selecting files and indicating the sending device that the selected files are to be transferred to a first receiving user equipment 12, for example using galvanic connection, e.g. Pop-Port, USB, or wireless connection, e.g. Bluetooth, infrared or WLAN, optical connection or direct connector connection, and further to a second receiving user 16 equipment, for example as an MMS message or an email. The sending device 10 may then automatically start a file transfer procedure for transferring the file(s) to the second receiving user equipment 16 via the first receiving user equipment 12.

In an embodiment, the user may be given a possibility to initiate the file transfer procedure and optionally also to make choices during the file transfer procedure. For example, at least one option may be displayed to the user, such as an accept option or a cancel option or another appropriate option, to be selected by the user for example by pressing an appropriate key or highlighting the selected option. Such various selection techniques are well known to a skilled person and are not further discussed herein.

A communication session between the sending device 10 and the first receiving user equipment 12 may be initiated by one or other of the two. In an embodiment, the sending device 10 queries, preferably automatically, information required for preparing the file transfer. The sending device may determine a type of a transfer method which is active or becomes active between the sending device 10 and the first receiving user equipment 12. The sending device 10 may then become aware of the possible limitations or other conditions relating to the transfer method. The awareness may be created by a protocol present in the sending device. In an embodiment, the sending device 10 may be provided with an access to an information site of the first receiving user equipment 12, such as the messaging application programming interface (API) of a mobile station, providing information of possible limitations relating to the transfer method.

In an embodiment, the first receiving user equipment 12 initiates a communication session between the first receiving user equipment and the sending device 10. The first receiving user equipment may provide the sending device with information of the transfer method to be used, such as galvanic connection, e.g. e.g. USB, Pop-Port, or wireless, e.g. Bluetooth, infrared, WLAN, or direct connector connection. Also information of the characteristics relating to the receiving user equipment, such as file size limitation, resolution and the like, may be provided. Furthermore, the sending device 10 may be informed about the method to be used for sending the message from the first receiving user equipment 12 to the second receiving user equipment 16. For example, the first receiving user equipment may send an information file comprising all the required information. In an alternative, simply an indication of the first transfer method, the second transfer method and/or the type of the receiving user equipment may be provided.

In some embodiments, for example when the sending device determines itself the active transfer method or if the first receiving user equipment sends the sending device an indication as explained above, the sending device may be provided with a list of different possible transfer methods and receiving user equipment. The list may provide the details for modifying the file, or the clone file, to fit to the limitations set by the transfer method and/or the receiving user equipment. The list may be provided, for example, as a piece of software, by the manufacturer or by a user.

Limitations may be set by the transfer method used between the sending device 10 and the first receiving user equipment 12 and/or by the transfer method used between the first receiving user equipment 12 and the second receiving user equipment 16. Limitations may also be set by the first and/or the second receiving user equipment. Limitations may relate to capacity of the transfer method or the receiving user equipment and may indicate, for example, the maximum file size supported by said transfer method or said user equipment.

In an embodiment, the sending device may also be informed of existence or non-existence of a support for a particular second transfer method in the first receiving user equipment. Such a second transfer method may be the MMS or the email. The information relating to the second transfer method may effect to the information sent from the sending device to the first receiving user equipment. For example, the sending device may include in the transferred information, in addition to the at least one data file, instructions concerning the type of the message to be created.

Furthermore, in an embodiment, the first receiving user equipment 12 may provide the sending device 10 tools, such as a piece of software, to assess whether the file to be transferred needs to be modified. In an alternative, the sending device is provided with the assessing information, for example as a piece of software, by the manufacturer or by a user prior to initiate the file transfer.

In an alternative, the user may give the sending device 10 information relating to the first receiving user equipment and/or transfer methods. For example, before or during the file transfer procedure, a list may be displayed to a user for selecting different transfer methods and different types of possible receiving user equipment.

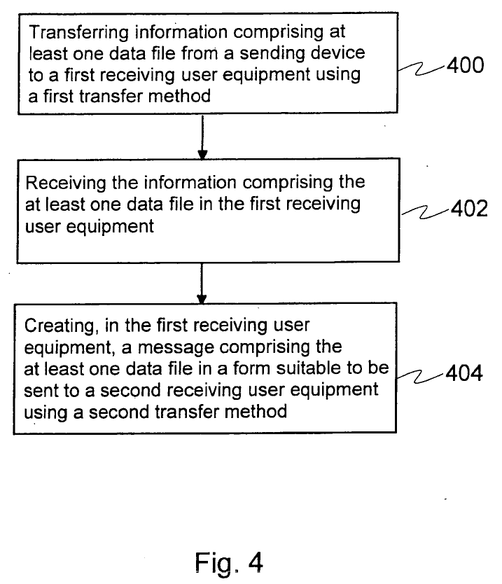

FIG. 4 shows a flow chart illustrating a further embodiment of the invention. In step 400, information comprising at least one data file is transferred from a sending device to a first receiving user equipment using a first transfer method. In step 402, the information comprising the at least one data file is received in the first receiving user equipment. In step 404, in the first receiving user equipment, a message comprising the at least one data file is created in a form suitable to be sent to a second receiving user equipment using a second transfer method.

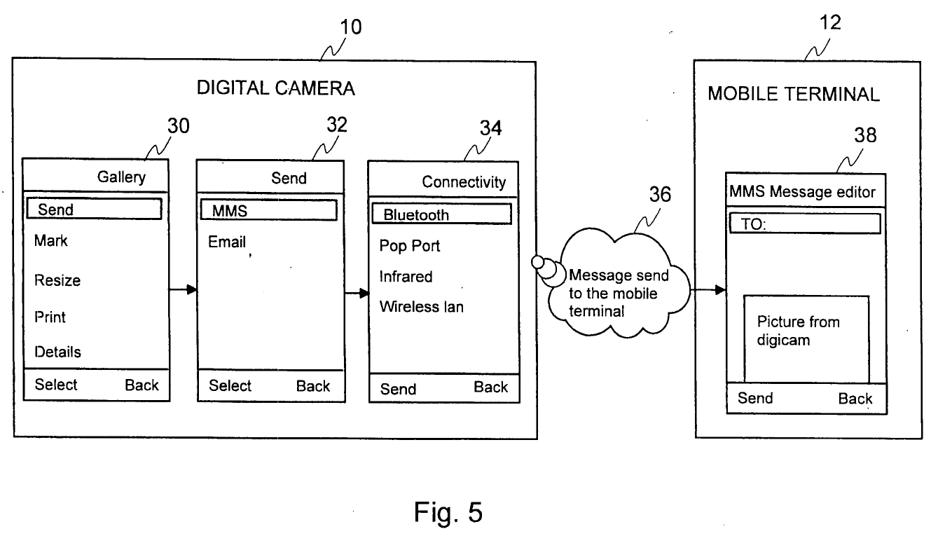

FIG. 5 shows an example of a user interface flow which may be used in an embodiment where an MMS message is to be sent from a digital camera as a sending device 10 via a mobile terminal as a first receiving user equipment 12 further to a second receiving user equipment (not shown) capable of receiving an MMS message. The user of the sending device 10 may select from the gallery 30, i.e. the device menu, of the sending device 10 a function to be carried out. In the FIG. 5 embodiment, “send” is selected. The “send” menu 32 is then displayed to the user, who may select the “MMS” option. In the embodiment of FIG. 5, the user then selects the connectivity method between the sending device 10 and the first receiving user equipment 12 from the “connectivity” menu 34. Here “Bluetooth” is selected. The user may be displayed also various other options. In an alternative, the sending device may obtain some of the information without any impact of the user. For example, the connectivity method between the sending device 10 and the first receiving user equipment 12 may be provided with the sending device in another appropriate manner, some examples of which are described in this specification. In the FIG. 5 embodiment, an auto-executable message 36 is then sent from the sending device 10 to the first receiving user equipment 12. In the first receiving user equipment, the auto-executable message 36 is received and opens automatically a message editor 38, creates a new message and attaches the data file(s), such as the image file(s), to the new message. The user may then add text or other information to the newly created MMS message. The MMS message may then be sent further to the second receiving user equipment in an appropriate manner. For example, the user may select and option “send” displayed by the message editor 38.

Preferably, the sending device 10 creates the message 36, or a command, such as an auto-executable message, to be sent to the first receiving user equipment 12 automatically based on the options provided to the sending device 10 by the user and/or by the first receiving user equipment 12. The message 36 may also be digitally signed. The message 36 preferably embeds the data to be transferred, such as images selected by the user, and the type of the message to be send further, such as MMS or email. Preferably, the message is executed at least partially automatically in the first receiving user equipment 12. Preferably, the user needs only to select an identification, such as a number, short number or name, of the second receiving user equipment and to initiate sending of the message.

The required information to be provided to the sending device 10 may depend on the receiving user equipment and/or the connectivity or transfer method. In the case of image file transfer, the required information may be the resolution and the file size supported by the transfer method and/or the receiving user equipment. For example, a Pop-Port interface may only allow transferring a maximum file size of 60 kB. The receiving user equipment may set a limit, for example, such that the file may be modified or transferred further in an efficient way. In an implementation, receiving user equipment may support sending a message, such as an MMS message, of a maximum size. For example, an image file having video graphics array (VGA) resolution of 640×480 pixels and maximum size of 32 kB may be supported, irrespective of the original image resolution and file size. As another example, a Bluetooth connection, to other devices than a PC and a printer, may only allow transferring an image file having VGA resolution of 640×480 pixels and maximum size of 100 kB. In the case of other type of file transfer, such as a music file, for example file size may be limited.

The sending device may assess, based on information relating to the first transfer method, the second transfer method and/or the first receiving user equipment, whether at least one of the file(s) to be transferred needs to be modified, such as re-sized and/or re-scaled. Preferably, assessing is carried out automatically.

If the sending device assesses that a file to be transferred needs or is instructed to be re-sized and/or re-scaled or otherwise modified, the sending device preferably creates a clone file of the original file. Creating a clone file leaves the original file intact and thereby the original file may remain in the sending device. When the file transfer is completed the clone file(s) may be deleted automatically or manually from the sending device for example to save the storing capacity of the sending device.

In an alternative, the original file may be modified directly instead of first creating a clone file. Such an embodiment may, however, not be advantageous, as the original file may be lost.

Based on the information relating to the receiving user equipment, the sending device modifies the file, preferably the clone file, to make it suitable for the file transfer. The file may be re-sized and/or re-scaled as explained above. For example in an image file, the original aspect ratio can thus be preserved.

The file modification is preferably automatic. In an alternative, the user may be given a possibility to make choices as explained above.

After having made the file(s), preferably the clone file(s), suitable for the file transfer, the sending device 10 starts sending the file(s) to the first receiving user equipment 12 using the connectivity selected by the user, determined by the sending device, informed by the first receiving user equipment or obtained in another way. The first receiving user equipment 12 receives the file(s), or the clone file(s), and creates, preferably automatically, a new message using for example a message editor 38. The received data file(s), such as the image file(s), are preferably automatically attached to the new message, as was explained above.

Embodiments of the invention may enable initiation of creation of a message in a format which can be forwarded via a first receiving user equipment to a second receiving user equipment already in the sending device, such as a digital camera. Embodiments of the invention may simplify the entire task of creating and sending messages, such as MMS and email messages, using multiple devices. User is required to know only few, or not at all, limitations relating to receiving user equipment and transfer methods. This method may also decrease even substantially the threshold of sending messages, such as MMS messages, using for example pictures taken with a standalone digital camera, when the camera is not an accessory of the user equipment used for sending the message.

Although the invention has been described in the context of particular embodiments, various modifications are possible without departing from the scope and spirit of the invention as defined by the appended claims. For example, the communication system may be any appropriate communication system. The sending and receiving devices may be any appropriate devices and the transfer technologies may be any appropriate transfer technologies, not limiting to the examples mentioned in the foregoing description.

1. A method for transferring data files between a sending device and a first receiving user equipment to be sent further to a second receiving user equipment, the method comprising:
receiving, in the first receiving user equipment, information comprising at least one data file transferred from the sending device using a first transfer method; and
in response to receiving the information, creating a message comprising the at least one data file in a form suitable to be sent to the second receiving user equipment using a second transfer method.

2. A method according to claim 1, wherein the step of receiving the information further comprises receiving an instruction to create the message.

3. A method according to claim 1, wherein the step of creating the message comprises automatically opening a message editor and automatically attaching the at least one data file to the message.

4. A method according to claim 1, wherein the step of creating the message further comprises allowing addition of other material to the message.

5. A method for transferring data files between a sending device and a first receiving user equipment to be sent further to a second receiving user equipment, the method comprising:
transferring at least one data file from the sending device to the first receiving user equipment using a first transfer method; and
instructing the first receiving user equipment to create a message comprising the at least one data file in a form suitable to be sent to the second receiving user equipment using a second transfer method.

6. A method according to claim 5, further comprising:
assessing, based on the first transfer method, if at least one of said at least one data file is to be modified; and
in response to finding that at least one of said at least one data file is to be modified, modifying said data file into a form suitable for transferring using the first transfer method.

7. A method according to claim 5, further comprising:
assessing, based on the second transfer method, if at least one of said at least one data file is to be modified; and
in response to finding that at least one of said at least one data file is to be modified, modifying said data file into a form suitable for transferring using the second transfer method.

8. A method according to claim 6 wherein the step of assessing comprises carrying out said assessing by the sending device.

9. A method according to claim 6, wherein the modifying step further comprises creating a clone data file of the original data file and modifying the clone data file.

10. A method according to claim 6, wherein the step of modifying comprises modifying the data file based on capacity limitations of the first transfer method.

11. A method according to claim 10, wherein the step of modifying comprises modifying the data file based on a maximum file size supported by the first transfer method.

12. A method according to claim 6, wherein the step of modifying comprises modifying the data file based on capacity limitations of the first receiving user equipment.

13. A method according to claim 12, wherein the step of modifying comprises modifying the data file based on a maximum file size supported by the first receiving user equipment.

14. A method according to claim 6, wherein the step of modifying comprises modifying the data file based on capacity limitations of the second transfer method.

15. A method according to claim 14, wherein the step of modifying comprises modifying the data file based on a maximum file size supported by the second transfer method.

16. A method according to claim 6, wherein the step of modifying comprises compressing the data file.

17. A method according to claim 6, wherein the step of transferring the information comprises transferring at least one image file.

18. A method according to claim 17, wherein the step of modifying comprises re-sizing the at least one image file.

19. A method according to claim 18, wherein the step of modifying further comprises re-scaling the at least one re-sized image file.

20. A method according to claim 6, wherein the step of modifying comprises changing the format of the data file.

21. A method according to claim 5, further comprising obtaining in the sending device an indication relating to the first transfer method.

22. A method according to claim 21, wherein the step of obtaining the indication relating to the first transfer method comprises determining by the sending device an active transfer method capable of transferring the information to the first receiving user equipment.

23. A method according to claim 21, wherein the step of obtaining the indication relating to the first transfer method comprises receiving in the sending device the indication sent by the first receiving user equipment.

24. A method according to claim 21, wherein the step of obtaining the indication relating to the first transfer method comprises displaying to a user of the sending device a list of transfer methods and allowing the user to select an indication belonging to the list.

25. A method according to claim 5, further comprising obtaining an indication relating to the second transfer method.

26. A method according to claim 25, wherein the step of obtaining an indication relating to the second transfer method comprises obtaining an indication of existence or non-existence of a support for a particular second transfer method in the first receiving device.

27. A method according to claim 26, wherein the step of obtaining an indication relating to the second transfer method comprises obtaining an indication of existence or non-existence of a support for multimedia message service and/or electronic mail.

28. A method according to claim 5, further comprising selecting the at least one data file to be transferred from a plurality of data files in the sending device.

29. A method for transferring data files between a sending device and a first receiving user equipment to be sent further to a second receiving user equipment, the method comprising:
transferring information comprising at least one data file from the sending device to the first receiving user equipment using a first transfer method;
receiving the information comprising the at least one data file in the first receiving user equipment; and
creating, in the first receiving user equipment, a message comprising the at least one data file in a form suitable to be sent to the, second receiving user equipment using a second transfer method.

30. A computer program comprising program code means for performing any of the steps according to claim 1-4 when the program is run on a computing means.

31. A computer program comprising program code means for performing any of the steps according to claim 5 when the program is run on a computing means.

32. A computer program comprising program code means for performing any of the steps according to claim 29 when the program is run on a computing means.

33. User equipment configured to:
receive information comprising at least one data file transferred from a separate device using a first transfer method;
in response to receiving the information, initiate an automatic creation of a message comprising the received at least one data file; and
send the message further to a second user equipment using a second transfer method.

34. User equipment according to claim 33 wherein the information comprises instruction to create the message.

35. User equipment according to claim 33 further configured to provide the separate device with an indication relating to the first transfer method.

36. User equipment according to claim 33 further configured to provide the separate device with an indication relating to the second transfer method.

37. A device configured to:
transfer at least one data file from the device to a first receiving user equipment using a first transfer method; and
instruct the first receiving user equipment to create a message comprising the at least one data file in a form suitable to be sent to a second receiving user equipment using a second transfer method.

38. A device according to claim 37, further configured to:
assess, based on the first transfer method, if at least one of said at least one data file is to be modified; and
in response to finding that at least one of said at least one data file is to be modified, modify the at least one data file into a form suitable for transferring using the first transfer method.

39. A device according to claim 37, further configured to:
assess, based on the second transfer method, if at least one of said at least one data file is to be modified; and
in response to finding that at least one of said at least one data file is to be modified, modify the at least one data file into a form suitable for transferring using the second transfer method.

40. A device according to claim 38, wherein the device is configured to create a clone data file of the original data file to be used in the modification.

41. A device according to claim 37, wherein the device is configured to carry out the modification by compressing the at least one data file.

42. A device according to claim 37, wherein at least one of said at least one data file is an image file.

43. A device according to claim 42, wherein the device is configured to carry out the modification by re-sizing the at least one image file.

44. A device according to claim 43, wherein the device is configured to carry out the modification by re-scaling the at least one re-sized image file.

45. A device according to claim 37, wherein the device is configured to carry out the modification by changing the format of the at least one data file.

46. A device according to claim 37, further configured to determine an active transfer method capable of transferring the information to the first receiving user equipment.

47. A device according to claim 37, further configured to receive an indication of the first transfer method from the first receiving user equipment.

48. A device according to claim 37, further configured to display to a user of the device a list of first transfer methods and to allow the user to select an indication belonging to the list.

49. A device according to claim 37, further configured to receive an indication of the second transfer method from the first receiving user equipment.

50. A device according to claim 37, further configured to display to a user of the device a list of second transfer methods and to allow the user to select an indication belonging to the list.

51. User equipment comprising:
receiving means for receiving information comprising at least one data file sent from a separate device using a first transfer method;
message creating means for creating, in response to receiving the information, a message comprising the received at least one data file; and
sending means for sending the message further to a second user equipment using a second transfer method.

52. A device comprising sending means for sending from the device to a first receiving user equipment using a first transfer method information comprising at least one data file and an instruction to create a message comprising the at least one data file in a form suitable to be sent to a second receiving user equipment using a second transfer method.

53. A device according to claim 52, further comprising:
assessing means for assessing, based on a transfer method, if at least one of said at least one data file is to be modified; and
modifying means for modifying, in response to finding that at least one of said at least one data file is to be modified, the at least one data file into a form suitable for transferring using said transfer method.

54. A device according to claim 52, further comprising clone creating means for creating a clone data file of the original data file.

55. A device according to claim 53, wherein the modifying means comprise compressing means for compressing the at least one data file.

56. A device according to claim 53, wherein the modifying means comprise data file format changing means for changing the format of the at least one data file.

57. An arrangement for transferring data files between a sending device and a first receiving user equipment to be sent further to a second receiving user equipment, the arrangement comprising:
sending means, in the sending device, for sending information comprising at least one data file to the first receiving user equipment using a first transfer method;
receiving means, in the first receiving user equipment, for receiving the information comprising the at least one data file; and
message creating means, in the first receiving user equipment, for creating a message comprising the at least one data file in a form suitable to be sent to the second receiving user equipment using a second transfer method.

58. An arrangement according to claim 57, wherein the message creating means are responsive to the reception of the information by the receiving means.

59. An arrangement according to claim 57, wherein the first receiving device comprises a mobile user equipment, a mobile station or a personal digital assistant.

60. An arrangement according to claim 57, wherein the sending device comprises a digital camera.

61. An arrangement according to claim 57, wherein the sending device does not support multimedia message service or electronic mail.

62. An arrangement according to claim 57, wherein the first transfer method is selected from a group comprising: universal serial bus port connection, Pop-Port connection, other galvanic connection, Bluetooth connection, infrared connection, wireless local area network connection, other wireless connection, direct connector connection or optical connection.

63. An arrangement according to claim 57, wherein the second transfer method is multimedia message service or electronic mail.

64. An arrangement according to claim 57, wherein the sending device and the first and the second receiving user equipment are stand-alone devices.

65. A device comprising:
a receiver to receive at least one data file transferred from a separate device using a first transfer method;
a control unit coupled to the receiver to initiate, automatically in response to receiving the at least one data file, creation of a message comprising the received at least one data file; and
a transmitter coupled to the control unit to transmit the message to a second user equipment using a second transfer method.

66. The device of claim 65 wherein the control unit creates the message in response to an instruction to create the message, said instruction received at the receiver with the at least one data file.

67. The device of claim 65 further comprising a transmitter coupled to the control unit to transfer to the separate device an indication relating to the first transfer method.

68. The device of claim 67 wherein said transmitter further transfers to the separate device an indication relating to the second transfer method.

69. A sending device comprising:
a transmitter to transfer at least one data file from the sending device to a first receiving user equipment using a first transfer method;
a control unit coupled to said transmitter to generate an instruction to the first receiving user equipment to create a message comprising the at least one data file in a form suitable to be sent to a second receiving user equipment using a second transfer method.

70. The sending device of claim 69 further comprising a memory coupled to said control unit for storing at least one stored data file;
wherein said control unit is further to make an assessment, based on the first transfer method, if the at least one stored data file is to be modified; and based on said assessment, said control unit is further to modify the at least one stored data file into the at least one data file that is in a form suitable for transferring using the first transfer method.

71. The sending device of claim 70, further comprising a memory coupled to said control unit for storing at least one stored data file;
wherein said control unit is further to make an assessment, based on both the second transfer method, if the at least one stored data file is to be modified; and based on said assessment, said control unit is further to modify the at least one stored data file into the at least one data file that is in a form suitable for transferring using the second transfer method.

72. The sending device of claim 70, wherein the at least one data file is a clone of the at least one stored data file.

73. The sending device of claim 70, wherein said control unit modifies the at least one stored data file by at least one of compressing, re-sizing, re-scaling, and changing a format of the at least one stored data file.

74. The sending device of claim 73, wherein the at least one stored data file is a stored image file.

75. The sending device of claim 69, further comprising a receiver coupled to the control unit to receive information describing the first transfer method.

76. The sending device of claim 75, wherein the information describing the first transfer method comprises an indication of the first transfer method from the first receiving user equipment.

77. The sending device of claim 76 wherein the information describing the first transfer method further includes information describing the second transfer method.

78. The sending device of claim 77, further comprising a receiver coupled to the control unit to receive the list of transfer methods, said list including transfer methods compatible with the first and second receiving devices.

79. The sending device of claim 69, further comprising a display coupled to the control unit to display a list of transfer methods compatible with the first receiving device, from which a user may select the first transfer method.

80. A receiving device comprising:
a receiver to receive at least one data file from a sending device using a first transfer method;
a control unit coupled to the receiver to create, in response to receiving the at least one data file, a message comprising the received at least one data file; and
a transmitter coupled to the control unit to send the message to a separate second device using a second transfer method.

81. A sending device comprising:
a transmitter to send, to a first receiving device using a first transfer method, information comprising at least one data file and an instruction to create a message comprising the at least one data file in a form that is suitable to be sent to a second receiving device using a second transfer method.

82. The sending device of claim 81, further comprising:
a memory to store a stored data file; and
a control unit coupled to the transmitter and to the memory to perform an assessment, based on at least one of the first and second transfer methods, if the stored data file is to be modified; and in response to the assessment, modifying the at least one stored data file to the at least one data file that is in a form suitable for transferring using at least one of the first and second transfer methods.

83. The sending device of claim 82, wherein modifying the at least one stored data file comprises creating a clone of the at least one stored data file.

84. The sending device of claim 82, wherein modifying the at least one stored data file comprises compressing the at least one stored data file.

85. The sending device of claim 82; wherein modifying the at least one stored data file comprises changing a format of the at least one stored data file.
